(19) United States
(12) Patent Application Publication
(10) Pub. No.: US 2026/0368608 A1
(43) Pub. Date: Nov. 19, 2026

(54) Matching Repulsion for Decoder Ensembling and Confidence Measures

(71) Applicant: Google LLC, Mountain View, CA (US)

(72) Inventor: Nathan Cody Jones, Los Angeles, CA (US)

(21) Appl. No.: 19/573,723

(22) Filed: Mar. 20, 2026

Related U.S. Application Data
(60) Provisional application No. 63/775,042, filed on Mar. 20, 2025.

(51) Int. Cl. G06N 10/70; G06N 10/40

(52) U.S. Cl. CPC G06N 10/70; G06N 10/40

(57) ABSTRACT

An example method is provided. The example method includes receiving an error syndrome that identifies a first subset of a set of nodes of a matching graph (MG). The example method includes selecting a first edge grouping of the set of edge groupings based on a first set of weights for the first edge grouping and other sets of weights for at least another portion of the set of edge groupings. The example method includes selecting a second edge grouping of the set of edge groupings based on at least a first set of updated weights for the first edge grouping and a second set of weights for the second edge grouping. The example method includes determining a set of qubit errors of the QCS based on a comparison between the first edge grouping and the second edge grouping.

### PRIORITY

The present application claims the benefit of priority of U.S. Provisional Patent Application No. 63/775,042, filed on Mar. 20, 2025, which is incorporated by reference herein.

### FIELD

The present disclosure relates generally to systems and methods for quantum computing.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b |1 [symbol] . The “0” and “1” states of a digital computer are analogous to the |0 and |1 basis states, respectively of a qubit.

### SUMMARY

Aspects and advantages of embodiments of the present disclosure will be set forth in part in the following description, or can be learned from the description, or can be learned through practice of the embodiments.

In an aspect, the present disclosure provides an example method. In some implementations, the example method includes receiving an error syndrome that identifies a first subset of a set of nodes of a matching graph (MG). In some implementations, the first subset of nodes define a set of edge groupings for a set of edges of the MG. In some implementations, each edge grouping of the set of edge groupings connects each node of the first subset of nodes with another node of the first subset of nodes or a boundary of the MG. In some implementations, the example method includes selecting a first edge grouping of the set of edge groupings based on a first set of weights for the first edge grouping and other sets of weights for at least another portion of the set of edge groupings. In some implementations, the example method includes selecting a second edge grouping of the set of edge groupings based on at least a first set of updated weights for the first edge grouping and a second set of weights for the second edge grouping. In some implementations, the example method includes determining a set of qubit errors of the QCS based on a comparison between the first edge grouping and the second edge grouping.

In an aspect, the present disclosure provides an example quantum computing system. The quantum computing system includes one or more quantum processors. The one or more quantum processors include one or more qubits. The one or more quantum processors are configured to execute one or more operations. The one or more operations include receiving an error syndrome that identifies a first subset of a set of nodes of a matching graph (MG). The first subset of nodes define a set of edge groupings for a set of edges of the MG. Each edge grouping of the set of edge groupings connects each node of the first subset of nodes with another node of the first subset of nodes or a boundary of the MG. The one or more operations include selecting a first edge grouping of the set of edge groupings based on a first set of weights for the first edge grouping and other sets of weights for at least another portion of the set of edge groupings. The one or more operations include selecting a second edge grouping of the set of edge groupings based on at least a first set of updated weights for the first edge grouping and a second set of weights for the second edge grouping. The one or more operations include determining a set of qubit errors of the QCS based on a comparison between the first edge grouping and the second edge grouping.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts a block diagram of a decoding pipeline configured to process measurement data to identify errors, according to example embodiments of the present disclosure.

FIGS. 2A, 2B, and 2C depict schematic diagrams of a reweighing scheme within a first matching graph, a second matching graph, and a third matching graph, respectively, according to example embodiments of the present disclosure.

FIGS. 3A and 3B depict schematic diagrams illustrating a path flip across nodes within a first matching graph and a second matching graph, respectively, according to example embodiments of the present disclosure.

FIG. 4 depicts a flowchart of a method for operating a quantum computing system, according to example embodiments of the present disclosure.

FIG. 5 depicts a block diagram of an example quantum computing system, according to example embodiments of the present disclosure.

### DETAILED DESCRIPTION

Example embodiments according to some aspects of the present disclosure are directed to Quantum computing systems. Quantum Computing systems may rely on quantum error correction (QEC) to protect information from noise and decoherence. A challenge in this field can be interpreting the signals indicating that errors have occurred. When a quantum processor operates, it can produce measurement data, often referred to as an error syndrome. Such error syndromes may indicate the presence of errors but do not explicitly identify which specific errors occurred. A decoding algorithm may be employed to analyze this syndrome and deduce the most likely set of errors that matches the observed data. This process may be referred to as decoding the error syndrome.

In some decoding approaches, decoders may be designed to find a single, most likely error configuration. However, this approach can be limited because a given syndrome may result from multiple different error patterns that have similar or identical probabilities. If a decoder simply selects one solution (e.g., the most likely solution) without considering alternatives, it may ignore valuable information regarding the reliability of that solution. For instance, if two different error patterns are equally (or at least similarly) likely but result in different logical outcomes for the quantum computation, selecting one may be akin to a coin flip, representing a low confidence in the correction. These decoding approaches may fail to capture this ambiguity, leading to uncharacterized logical errors or an inability to assess the confidence level of the decoding process.

The embodiments described herein provide methods and systems for operating a quantum computing system (QCS). Some embodiments may generate a diversity of probable error solutions (e.g., two or more) rather than a single solution. These embodiments may employ a technique referred to as “matching repulsion”. In these approaches, a decoder is run to find a first likely valid assignment of errors (a matching) for a given syndrome. Once this first solution is found, the embodiments “artificially” penalize the specific components (e.g., edges or hyperedges) of that solution.

This penalization acts as a form of repulsion. By increasing the “weight” or “cost” of the path taken by the first solution, the decoder is encouraged—or “repelled”—to find a different, alternative solution during a subsequent run. This process may not forbid the decoder from selecting the original path if it is truly the only option, but it makes that path less attractive compared to other potential solutions. This allows the system to discover multiple distinct, highly probable explanations for the observed error syndrome. These multiple solutions can then be compared to determine a confidence measure (such as a logical gap) or combined to improve the overall accuracy of the error correction.

In an example embodiment, an error syndrome is received from the quantum hardware. This syndrome corresponds to a set of nodes in a matching graph (or hypergraph) that need to be paired or grouped together. A decoding algorithm may be executed to select a first edge grouping that satisfies the syndrome, utilizing an initial set of weights associated with the edges (representing error probabilities).

Upon selecting this first grouping, the weights of at least a portion of the edges included in that first edge grouping may be updated. For example, the embodiments may add a fixed numerical value to the weights of the used edges, effectively lowering their probability in the eyes of the decoder. The decoder may then be executed a second time using these updated weights. Because the original path is now more “expensive,” the decoder attempts to find a second, different edge grouping that also satisfies the syndrome.

This process can be repeated iteratively or utilizing random weight updates to generate an ensemble of solutions. The resulting solutions may then be analyzed. If the first and second groupings are chemically different (e.g., they differ by a logical operator), the system can calculate a “logical gap” based on the difference in their original probabilities. This gap serves as a confidence score; a small gap implies less certainty about the correction, potentially triggering a decision to discard a resource state or apply more robust decoding resources.

The embodiments include methods for operating a quantum computing system (QCS). One non-limiting method includes receiving an error syndrome that identifies a first subset of nodes of a matching graph (MG). This subset of nodes defines features for a set of edge groupings, where each edge grouping connects the nodes to one another or to a boundary.

The method may further include selecting a first edge grouping of the set of edge groupings based on a first set of weights for the first edge grouping and other sets of weights for other portions of the edge groupings. This corresponds to an initial decoding run where an objective function (e.g., minimum weight matching) may be employed.

The method may then select a second edge grouping based on at least a first set of updated weights for the first edge grouping and a second set of weights for the second edge grouping. This step embodies the repulsion technique, where the weights of the first grouping are modified (e.g., increased) to influence the selection of the second grouping. The method may then determine a set of qubit errors for the QCS based on a comparison between the first edge grouping and the second edge grouping. This comparison allows for the identification of logical operator flips or the creation of an ensemble solution.

The embodiments provide several technical advantages over conventional approaches. One benefit is the ability to generate a diversity of decoding solutions without modifying the structural topology of the error graph. Unlike approaches that include adding nodes or boundaries to find alternative solutions, the present embodiments operate by modifying weights, making the technique applicable to arbitrary graph structures.

Furthermore, the embodiments are applicable to hypergraphs, where errors may be associated with hyperedges connecting more than two nodes. This generality allows the technique to be used with a wide variety of quantum error correcting codes beyond those that can be represented by simple matching graphs.

Another technical effect is the efficient calculation of confidence measures, such as the logical gap. By using matching repulsion to actively guide the decoder toward alternative solutions, the embodiments may be employed to identify competing logical error classes more efficiently than passive random ensembling. This confidence measure enables active control schemes, such as the real-time allocation of decoding resources or the post-selection of high-quality logical states, thereby improving the overall fidelity of the QCS. Additionally, the embodiments are compatible with windowed decoding, allowing it to be parallelized across different spatial or temporal regions of the matching graph.

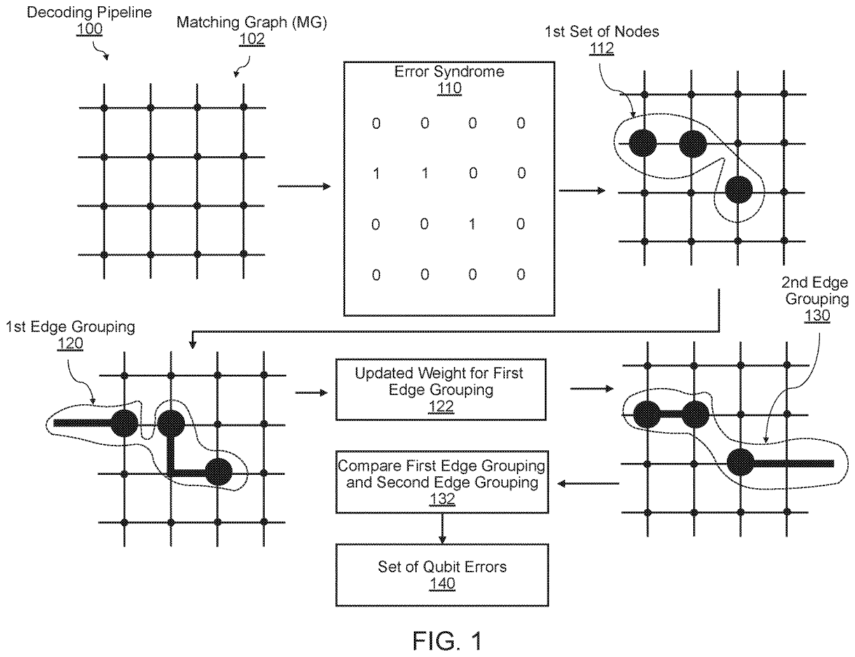

FIG. 1 depicts a block diagram of a decoding pipeline 100, according to an example embodiment of the present disclosure. The decoding pipeline 100 can be configured to process measurement data from quantum hardware to identify errors. The decoding pipeline 100 can include various logic modules, classical memory structures, and processing units configured to implement quantum error correction. In some instances, the decoding pipeline 100 may be integrated into a classical controller of a quantum computing system, or it may be implemented as a distributed computing service.

The decoding pipeline 100 can be configured as a classical logic circuit, a processor executing instructions, or a specialized hardware accelerator, such as a field programmable gate array (FPGA) or application-specific integrated circuit (ASIC). The decoding pipeline 100 can identify at least a subset of a set of edge grouping based on a received and/or accessed error syndrome (e.g., error syndrome 110). The decoding pipeline 110 can additionally manage the set of edge groupings and implement iterative weight-based decoder guidance. In some instances, the decoding pipeline 100 can operate in real-time to match the clock speed of the quantum processor, allowing for low-latency feedback and control.

The matching graph 102 can be based on a quantum error correction (QEC) code and an error model that includes a set of error mechanisms. The matching graph 102 can model the relationships between different qubit error events and the detection events they trigger. The matching graph 102 can utilize a coordinate system that corresponds to the physical or logical layout of a qubit register.

Each edge of the set of edges of the matching graph 102 can correspond to an error mechanism of a set of error mechanisms. Each edge can have a weight based on a prior probability associated with the error mechanism. In some instances, the weight of each edge is based on a logarithm of the prior probability. The matching graph 102 can be a hypergraph where a first subset of the set of edges includes at least one hyperedge connecting three or more nodes.

Each edge grouping of the set of edge groupings is consistent with the received error syndrome 110 and can include a separate subset of the set of edges, which may be referred to as an edge grouping. These edge groupings can represent a hypothesized pattern of physical qubit errors that would result in the observed measurement data (e.g., error syndrome 110). In some instances, the edge groupings are defined such that they satisfy the parity constraints of the QEC code, effectively matching detection events to each other or to a code boundary.

The error syndrome 110 can be received or generated based on measurements of a set of qubits. The error syndrome 110 can be based on a qubit measurement measured during an execution of a QEC code, such as a surface code, a color code, an LDPC code, etc. The error syndrome 110 can represent a collection of parity check violations that indicate the presence of one or more errors in the qubit register.

The error syndrome 110 can identify a first subset of nodes 112 of the matching graph 102. These nodes 112 can correspond to specific detectors or parity check circuits that have been triggered. The nodes 112 can define features for a set of edge groupings, where each grouping represents a candidate solution for the decoding problem. In some instances, the nodes 112 are distributed across both spatial and temporal dimensions, reflecting the history of parity measurements over multiple cycles.

The first edge grouping 120 can be selected based on a first set of weights for the first edge grouping and other sets of weights for at least another portion of the set of edge groupings. The selection can involve an objective function and a selection criteria. The objective function can assign an objective value to each edge grouping. For instance, the objective function can assign a first objective value to the first edge grouping 120. This objective value can be based on a summation of each weight of the set of weights for the edge grouping.

The selection criteria can be employed to select the first edge grouping 120 based on a first ranking of the set of edge groupings. The objective function can assign other objective values to the other portion of the set of edge groupings, allowing the selection criteria to identify the best solution (e.g., the objective value fits what the objective function is looking for, a minimized objective value, a maximized objective value, etc.). When selecting the first edge grouping 120 based on the first ranking, the selection criteria has a first probability for selecting the first edge grouping over the second edge grouping, and a second probability for selecting the second edge grouping over the first edge grouping. In some instances, the first probability is greater than the second probability, as the first grouping may represent the most likely error pattern.

The updated weight for first edge grouping 122 can be generated in response to selecting the first edge grouping 120. Generating the first set of updated weights can include updating a first weight of a first edge included in the first edge grouping 120. This update may involve adding and/or subtracting a scalar value to the weight and/or multiplying the weight by a penalty factor. The objective function can assign an updated objective value to the first edge grouping 120 based on the first set of updated weights. The selection criteria can have an updated probability of selecting the first edge grouping 120 based on this updated objective value, where the first probability for selecting the grouping is greater than the updated probability.

The updated weight for first edge grouping 122 can discourage the decoder from selecting the same path in a subsequent run. By increasing the weights of the edges used in the first solution, the objective value of the first edge grouping is increased (if minimizing), making it less attractive to the selection criteria. This mechanism can allow the decoding pipeline 100 to explore the solution space and find alternative candidates that are also consistent with the error syndrome 110.

The second edge grouping 130 can be selected based on the first set of updated weights for the first edge grouping 120 and a second set of weights for the second edge grouping 130. The objective function can assign a second objective value to the second edge grouping 130. A second ranking of the set of edge groupings can be generated based on the updated objective value assigned to the first edge grouping 120 and the second objective value assigned to the second edge grouping 130.

The selection criteria can be employed to select the second edge grouping 130 based on this second ranking. In this second selection phase, the selection criteria can have a first probability for selecting the second edge grouping 130 over the first edge grouping 120, and a second probability for selecting the first edge grouping 120 over the second edge grouping 130. In some instances, due to the weight update, the first probability for selecting the second edge grouping 130 is now greater than the second probability for selecting the first edge grouping 120.

The logic step 132 can be configured to perform a comparison between the first edge grouping 120 and the second edge grouping 130. This comparison can involve an ensemble of edge groupings that includes the first edge grouping 120, the second edge grouping 130, and potentially many other groupings generated through repeated repulsion iterations. The logic step 132 can implement a complementary gap algorithm to compute a gap between the first edge grouping 120 and the second edge grouping 130, which may be referred to as a gap between the first edge grouping and the second edge grouping.

The logic step 132 can determine if the groupings differ by a logical operator, representing different logical error classes. The gap between the solutions, when evaluated using their initial weights, can serve as a measure of decoding confidence. A small gap can indicate that multiple logical outcomes are nearly equally probable, while a large gap indicates high confidence in a single logical correction. In some instances, the logic step 132 can aggregate probabilities across the ensemble of edge groupings to determine the most likely logical correction class.

The set of qubit errors 140 can be determined based on the comparison performed by the logic step 132. The set of qubit errors 140 can represent the physical locations and types of errors (e.g., Pauli X, Y, Z errors, etc.) to be mitigated. Based on this determination, the quantum computing system can apply corrective gates or update the frame of the logical qubits.

It should be understood that the decoding pipeline 100 may include additional components and steps not explicitly labeled in FIG. 1, such as classical memory buffers, syndrome extraction logic, or communication interfaces for receiving measurement data. The specific arrangement, materials, configuration, and order may vary, provided they achieve the generation of multiple decoding solutions for a given syndrome. Furthermore, the objective function and selection criteria can be implemented using various optimization algorithms, including the Blossom algorithm, belief propagation, or neural network-based decoders.

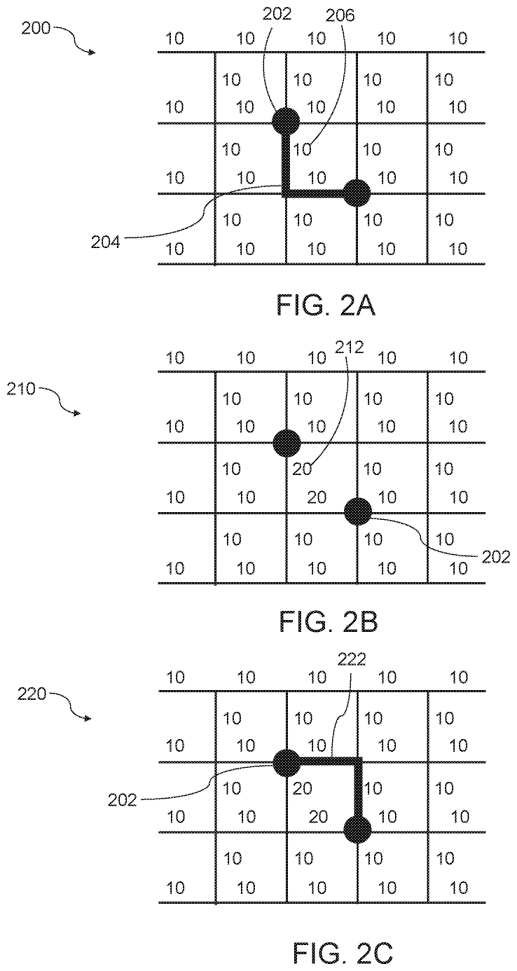

FIG. 2A, FIG. 2B, and FIG. 2C depict schematic diagrams of a reweighing scheme within a first matching graph 200, a second matching graph 210, and a third matching graph 220, according to an example embodiment.

In FIG. 2A, the first matching graph 200 includes a set of nodes 202 and a plurality of edges characterized by initial weights 206 (e.g., an initial weight value of 10). A decoder can select a first edge grouping 204 to satisfy a detected syndrome. The first edge grouping 204 may represent the shortest path or lowest-cost configuration based on the initial weights 206.

In FIG. 2B, the weights of the edges included in the first edge grouping 204 can be modified to generate updated weights 212 (e.g., increased to a value of 20). This update results in the second matching graph 210. The increase in weight may be configured as a fixed penalty or as a multiplicative factor applied to the initial weights 206. This update may involve adding a scalar value to used edges or increasing the initial weight to a penalized value to reduce the likelihood of the selection criteria picking it again.

In FIG. 2C, a subsequent decoding run on the third matching graph 220 (utilizing the updated weights 212) can result in the selection of a second edge grouping 222. Since the original edges now have higher costs, the second edge grouping 222 may, in some instances, choose a different set of edges to connect the nodes 202. This second edge grouping 222 may represent the second-most-likely error pattern according to the original error model, which the decoder would have previously ignored.

It should be understood that the matching graphs 200, 210, and 220 may include additional components/steps not explicitly labeled in FIG. 2A-2C, such as hyperedges connecting three or more nodes or boundary nodes representing transitions to a code boundary. The specific arrangement, materials, configuration, and/or order may vary, provided they achieve a weight-based repulsion that influences decoder path selection. Furthermore, the initial weights 206 can be based on a logarithm of a prior probability associated with an error mechanism. In some instances, the system may keep a history of updates across multiple stages, such that edges matched in both a first stage and a second stage receive even higher weights in a third stage to continue repelling the decoder from those specific solutions.

It should be understood that although the first matching graph 200 is shown as having a consistent set of weights that every pathway may have a different set of weights. For instance, the graph could have a weight of 10 for one potential edge, 5 for another, 3 for another, 103 for another, etc. The system may be determining a matching path based on the highest and/or lowest individual weights, the highest and/or lowest cumulative weights, etc. The weights may, in some instances, be updated by lowering a set number of weights, multiplying the weights, dividing the weights, performing a logarithmic or fractional operation, etc. It should be understood that in some circumstances the weights may be changed by multiple of these operations.

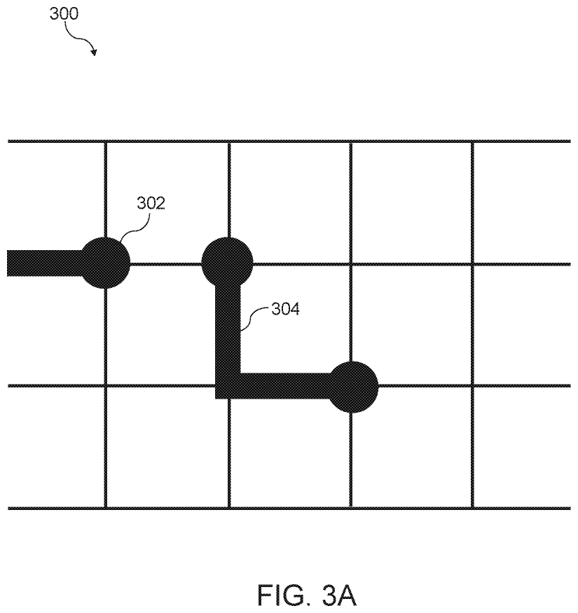

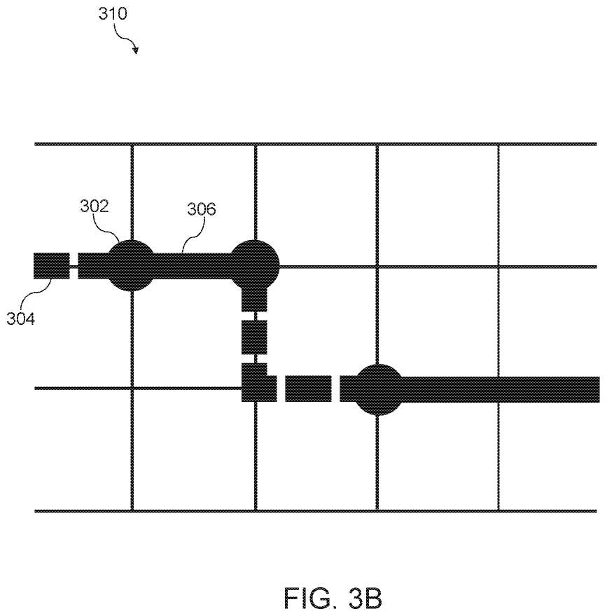

FIG. 3A and FIG. 3B depict schematic diagrams of a path flip within a first matching graph 300 and a second matching graph 310, according to an example embodiment. FIG. 3A shows a first edge grouping 304 connecting a set of nodes 302. This first edge grouping 304 may be associated with a first logical outcome for the quantum code. FIG. 3B shows a second edge grouping 306 that results from penalizing the first edge grouping 304. In this instance, the second edge grouping 306 represents a path that has flipped across the graph, which can correspond to a different logical state in a surface code or other topological code.

The selection of the second edge grouping 306 after penalization may help identify the logical gap. The logical gap, in some instances, is the difference in weights between the two solutions when scored using their initial probabilities. A small logical gap may indicate low confidence in the correction. Conversely, a large logical gap may indicate high confidence. It should be understood that the matching graphs 300 and 310 may include additional components and/or steps not explicitly labeled in FIG. 3A-3B, such as multiple logical boundaries or non-topological connections. The specific arrangement, materials, configuration, order may vary, provided they achieve the identification of a logical gap or an ensemble of solutions. Furthermore, the difference in weights between the first edge grouping 304 and the second edge grouping 306 can be used to calculate a confidence measure that informs an active control system, which can include a logic circuit configured to initiate a re-preparation of a quantum resource state in response to the confidence measure falling below a threshold.

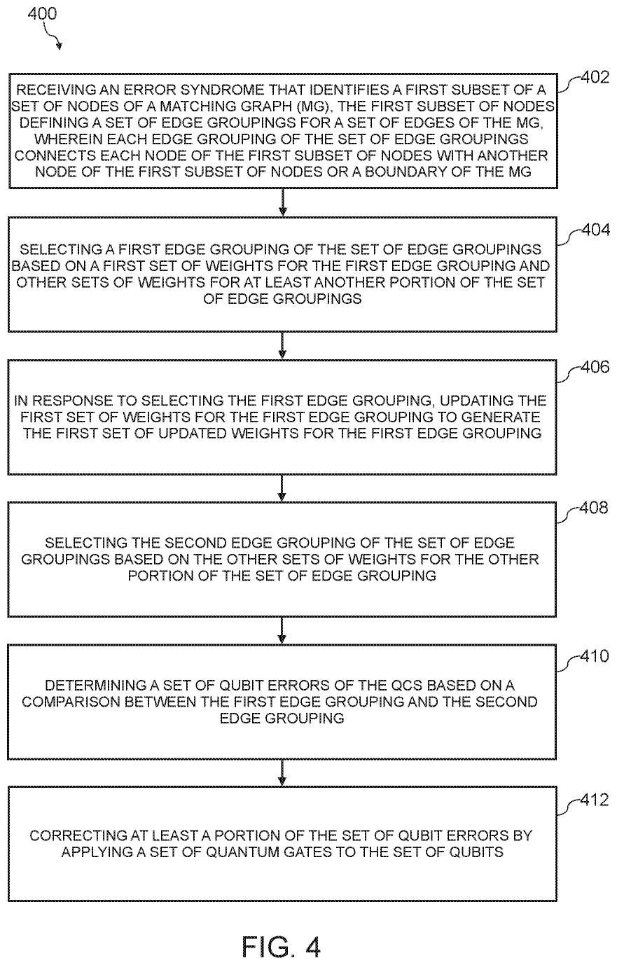

FIG. 4 depicts a flowchart of a method 400 for operating a quantum computing system (QCS), according to an example embodiment. Those of ordinary skill in the art, using the disclosures provided herein, will understand that various steps of any of the methods described herein can be omitted, expanded, performed simultaneously, rearranged, and/or modified in various ways without deviating from the scope of the present disclosure. In addition, various steps (not illustrated) can be performed without deviating from the scope of the present disclosure.

The method 400 can be executed by a classical processor in communication with quantum hardware. At step 402, the method 400 can include receiving an error syndrome that identifies a first subset of nodes of a matching graph (MG), the first subset of nodes defining a set of edge groupings for a set of edges of the MG, wherein each edge grouping of the set of edge groupings connects each node of the nodes with another node of the nodes or a boundary of the MG. This step may include retrieving pre-computed edge weights from a memory and identifying active detection events.

At step 404, the method 400 can include selecting a first edge grouping of the set of edge groupings based on a first set of weights for the first edge grouping and other sets of weights for at least another portion of the set of edge groupings. At step 406, in response to selecting the first edge grouping, the method 400 can include updating the first set of weights for the first edge grouping to generate the first set of updated weights for the first edge grouping. The update may include adding a scalar value to the weights of all used edges or randomly flipping weights back to their original values to introduce diversity.

At step 408, the method 400 can include selecting the second edge grouping of the set of edge groupings based on the other sets of weights for the other portion of the set of edge grouping and the first set of updated weights. This step can be generalized to imperfect hypergraph matching, where a greedy algorithm is employed to merge split hyperedges. In such a greedy approach, hyperedges of a merge graph may be sorted by weight and processed to mark nodes, with matching repulsion applied by increasing the weights of previously merged hyperedges. At step 410, the method 400 can include determining a set of qubit errors of the QCS based on a comparison between the first edge grouping and the second edge grouping. At step 412, the method 400 can optionally include correcting at least a portion of the set of qubit errors by applying a set of quantum gates to the set of qubits to restore the encoded information.

The QCS may include a set of qubits. In various embodiments, method 400 may further include in response to determining the set of qubit errors, correcting at least a subset of the set of qubit errors. The subset of qubit errors may correspond to at least a subset of the set of qubit errors. Correcting the subset of qubit errors may include applying a set of quantum logic gates to the subset qubits to correct a quantum state of the subset of qubits.

It should be understood that the method 400 may include additional components and/or steps not explicitly labeled in FIG. 4, such as performing an ensembling algorithm (e.g., matching synthesis or matching pooling) to combine multiple solutions. The method 400 can also include executing a windowing process to divide the matching graph into spatial or temporal windows for parallelized real-time decoding. The specific arrangement, materials, configuration, and/or order may vary, provided they achieve the determination of qubit errors through iterative weight-based decoder guidance. Furthermore, the method 400 can be applied to classical codes, such as low-density parity-check (LDPC) codes used in wireless communication protocols (e.g., Wi-Fi or cellular networks).

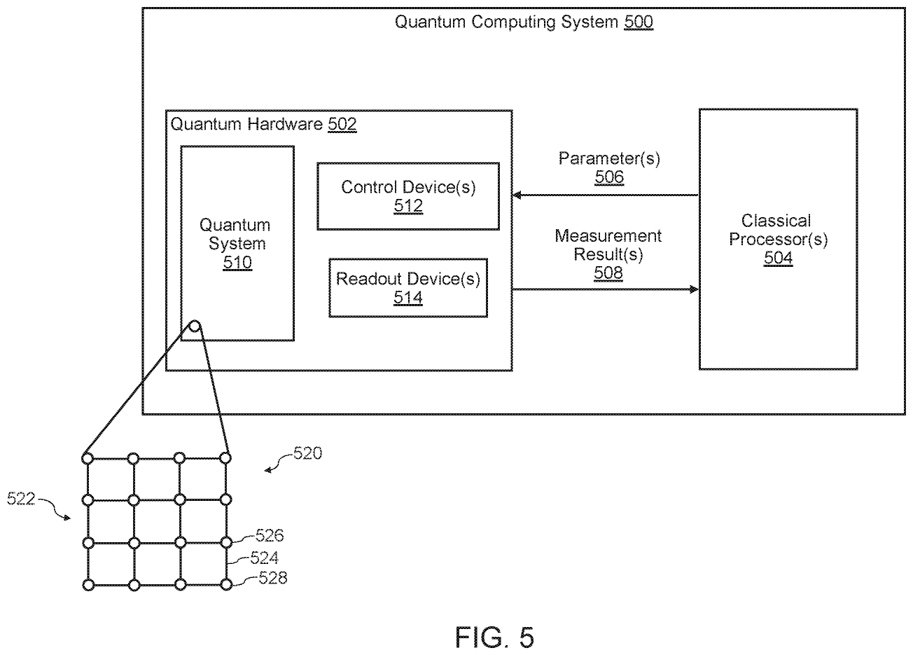

FIG. 5 depicts an example quantum computing system 500. The system 500 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 500 includes quantum hardware 502 in data communication with one or more classical processors 504. The classical processors 504 can be configured to execute computer-readable instructions stored in one or more memory devices to perform operations, such as any of the operations described herein. The quantum hardware 502 includes components for performing quantum computation. For example, the quantum hardware 502 includes a quantum system 510, control device(s) 512, and readout device(s) 514 (e.g., readout resonator(s)). The quantum system 510 can include one or more multi-level quantum subsystems, such as a register of qubits (e.g., qubits 520). In some implementations, the multi-level quantum subsystems can include superconducting qubits, such as flux qubits, charge qubits, transmon qubits, gmon qubits, spin-based qubits, and the like. In some implementations, the superconducting qubits may be located in a cryostat to cool the qubits to superconducting temperatures (e.g., less than about 3 Kelvin). However, aspects of the present disclosure are not limited to superconducting qubits. In some examples, any suitable qubit structure may be used without deviating from the scope of the present disclosure, such as photonic qubits, trapped ion qubits, spin qubits, neutral atom qubits, quantum dot qubits, molecular qubits, or other qubits.

The type of multi-level quantum subsystems that the system 500 utilizes may vary. For example, in some cases the system may include one or more readout device(s) 514 coupled (e.g., electromagnetically coupled) to one or more qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dot, or phosphorus impurity qubits.

Quantum circuits may be constructed and applied to the register of qubits included in the quantum system 510 via multiple control lines that are coupled to one or more control devices 512. Example control devices 512 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 512 may be configured to operate on the quantum system 510 through one or more respective control parameters (e.g., one or more physical control parameters). For example, in some implementations, the multi-level quantum subsystems may be superconducting qubits and the control devices 512 may be configured to provide control pulses to control lines to generate magnetic fields to control the qubits. For example, in some implementations the multi-level quantum subsystems may be neutral atom qubits and the control devices 512 may be configured to provide control pulses to control lines to generate magnetic fields to control the qubits. Neutral atom qubits can comprise arrays of single atoms, trapped and manipulated by focused laser beams called optical tweezers, as quantum bits (qubits). By exciting these atoms to high-energy Rydberg states, they interact over large distances to perform fast, high-fidelity quantum gates, with readout performed by detecting the internal quantum state (hyperfine or electronic levels) of individual atoms using fluorescence imaging or other suitable techniques.

The quantum hardware 502 may further include readout devices 514 (e.g., readout resonators). Measurement results 508 obtained via readout devices 514 may be provided to the classical processors 504 for processing and analyzing. In some implementations, the quantum hardware 502 may include a quantum circuit and the control device(s) 512 and readout device(s) 514 may implement one or more quantum logic gates that operate on the quantum system 510 through physical control parameters (e.g., microwave pulses) that are sent through wires included in the quantum hardware 502. The readout device(s) 514 may be configured to perform quantum measurements on the quantum system 510 and send measurement results 508 to the classical processors 504.

In addition, the quantum hardware 502 may be configured to receive data specifying physical control qubit parameter values 506 from the classical processors 504. The quantum hardware 502 may use the received physical control qubit parameter values 506 to update the action of the control device(s) 512 and readout device(s) 514 on the quantum system 510. For example, the quantum hardware 502 may receive data specifying new values representing voltage strengths of one or more digital to analog converters (DACs) included in the control devices 512 and may update the action of the DACs on the quantum system 510 accordingly. The classical processors 504 may be configured to initialize the quantum system 510 in an initial quantum state, e.g., by sending data to the quantum hardware 502 specifying an initial set of parameters 506.

In some implementations, the readout device(s) 514 can take advantage of a difference in the impedance for the |0> and |1> states of an element of the quantum system, such as a qubit, to measure the state of the element (e.g., the qubit). For example, the resonance frequency of a readout resonator can take on different values when a qubit is in |0 [symbol] or the state |1 [symbol] , due to the nonlinearity of the qubit. Therefore, a microwave pulse reflected from the readout device 514 carries an amplitude and phase shift that depend on the qubit state. In some implementations, a Purcell filter can be used in conjunction with the readout device(s) 514 to impede microwave propagation at the qubit frequency.

In some embodiments, the quantum system 510 can include a plurality of qubits 520 arranged, for instance, in a two-dimensional grid 522. For clarity, the two-dimensional grid 522 depicted in FIG. 5 includes 4×4 qubits; however, in some implementations the system 510 may include a smaller or a larger number of qubits. In some embodiments, the multiple qubits 520 can interact with each other through multiple qubit couplers, e.g., qubit coupler 524. The qubit couplers can define nearest neighbor interactions between the multiple qubits 520. In some implementations, the strengths of the multiple qubit couplers are tunable parameters. In some cases, the multiple qubit couplers included in the quantum computing system 500 may be couplers with a fixed coupling strength.

In some implementations, the multiple qubits 520 may include data qubits, such as qubit 526 and measurement qubits, such as qubit 528. A data qubit is a qubit that participates in a computation being performed by the system 500. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 520 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 520 can be chosen before a computation is performed. In some examples, the operating of the frequencies for the qubits 520 may be adjusted using AC Stark shift according to examples of the present disclosure before a quantum computation, quantum gate, and/or a quantum algorithm is performed.

FIG. 5 depicts one example quantum computing system that can be used to implement the methods and operations according to example aspects of the present disclosure. Other quantum computing systems can be used without deviating from the scope of the present disclosure.

In various implementations, the example system 500 can be implemented as a client device, a server device, or both. The example system 500 can be implemented as part of a distributed computing system. The example system 500 can be implemented along with other example systems, which may be the same or different. The example system 500 can be implemented in a server farm or other facility that operates multiple computing systems to provide computational services to or on behalf of a plurality of client systems. Advantageously, techniques according to example aspects of the present disclosure can provide for improved calibration and maintenance of computing facilities, increasing service uptime, decreasing failure rates, etc.

Example aspects of the present disclosure are set forth below. Any of the below features or examples may be used in combination with any of the embodiments or features provided in the present disclosure.

In an aspect, the present disclosure provides an example method. In some implementations, the example method includes receiving an error syndrome that identifies a first subset of a set of nodes of a matching graph (MG). In some implementations, the first subset of nodes define a set of edge groupings for a set of edges of the MG. In some implementations, each edge grouping of the set of edge groupings connects each node of the first subset of nodes with another node of the first subset of nodes or a boundary of the MG. In some implementations, the example method includes selecting a first edge grouping of the set of edge groupings based on a first set of weights for the first edge grouping and other sets of weights for at least another portion of the set of edge groupings. In some implementations, the example method includes selecting a second edge grouping of the set of edge groupings based on at least a first set of updated weights for the first edge grouping and a second set of weights for the second edge grouping. In some implementations, the example method includes determining a set of qubit errors of the QCS based on a comparison between the first edge grouping and the second edge grouping.

In some implementations, the example method includes in response to selecting the first edge grouping, updating the first set of weights for the first edge grouping to generate the first set of updated weights for the first edge grouping. In some implementations, the example method includes selecting the second edge grouping of the set of edge groupings further based on the other sets of weights for the other portion of the set of edge groupings.

In some implementations of the example method, each edge grouping of the set of edge groupings includes a separate subset of the set of edges. In some implementations of the example method, each edge of the set of edges has a weight. In some implementations of the example method, each edge grouping of the set of edge groupings has a set of weights that includes the weight of each edge of the subset of edges that is included in the edge group.

In some implementations of the example method, selecting the first edge grouping and identifying the second edge grouping are further based on an objective function and a selection criteria. In some implementations of the example method, the objective function assigns an objective value to each edge grouping of the set of edge groupings based on the set of weights for the edge grouping such that a ranking of the set of edge groupings is defined based on the objective function assigning the objective value to each edge grouping in the set of edge groupings. In some implementations of the example method, the selection criteria is employed to select an edge grouping of the set of edge groupings based on the ranking of the set of edge groupings.

In some implementations of the example method, the objective value that the objective function assigns to each edge grouping of the set of edge groupings is further based on a summation of each weight of the set of weights for the edge grouping.

In some implementations of the example method, selecting the first edge grouping includes comparing a first objective value that the objective function assigns to the first edge grouping to other objective values that the objective function assigns to the other portion of the set of edge groupings. In some implementations of the example method, the objective function assigns the first objective value to the first edge grouping based on the first set of weights for the first edge grouping.

In some implementations of the example method, selecting the second grouping includes comparing a second objective value that the objective function assigns to the second edge grouping to an updated objective value that the objective function assigns to the first edge grouping. In some implementations of the example method, the objective function assigns the updated objective value to the first edge grouping based on the first set of updated weights for the first edge grouping and the objective function assigns the second objective value to the second edge grouping based on the second set of weights for the second edge grouping.

In some implementations of the example method, selecting the first edge grouping includes employing the objective function to assign a first objective value to the first edge grouping. In some implementations of the example method, assigning the first objective value to the first edge grouping is based on the first set of weights for the first edge grouping. In some implementations of the example method, selecting the first edge grouping includes employing the objective function to assign a second objective value to the second edge grouping. In some implementations of the example method, assigning the second objective value to the second edge grouping is based on the second set of weights for the second edge grouping. In some implementations of the example method, selecting the first edge grouping includes generating a first ranking of the set of edge groupings based on the first objective value assigned to the first edge grouping and the second objective value assigned to the second edge grouping. In some implementations of the example method, selecting the first edge grouping includes employing the selection criteria to select the first edge grouping based on the first ranking of the set of edge groupings.

In some implementations of the example method, selecting the second edge grouping includes employing the objective function to assign an updated objective value to the first edge grouping. In some implementations of the example method, assigning the updated objective value to the first edge grouping is based on the first updated set of weights for the first edge grouping. In some implementations of the example method, selecting the second edge grouping includes generating a second ranking of the set of edge groupings based on the updated objective value assigned to the first edge grouping and the second objective value assigned to the second edge grouping. In some implementations of the example method, selecting the second edge grouping includes employing the selection criteria to select the second edge grouping based on the second ranking of the set of edge groupings.

In some implementations of the example method, when selecting the second edge grouping based on the second ranking of the set of edge groupings, the selection criteria has a first probability for selecting the second edge grouping over the first edge grouping, the selection criteria has a second probability for selecting the first edge grouping over the second edge grouping, and the first probability is greater than the second probability.

In some implementations of the example method, when selecting the first edge grouping based on the first ranking of the set of edge groupings, the selection criteria has a first probability for selecting the first edge grouping over the second edge grouping. In some implementations of the example method, the selection criteria has a second probability for selecting the second edge grouping over the first edge grouping, and the first probability is greater than the second probability.

In some implementations of the example method, the objective function assigns a first objective value to the first edge grouping based on the first set of weights for the first edge grouping, the selection criteria has a first probability of selecting the first edge grouping based on the first objective value for the first edge grouping. In some implementations of the example method, updating the first set of weights for the first edge grouping includes updating at least a first weight of a first edge included in the first edge grouping to generate the first set of updated weights for the first edge grouping such that the objective function assigns an updated objective value to the first edge grouping based on the first set of updated weights for the first edge grouping, wherein the selection criteria has an updated probability of selecting the first edge grouping based on the updated objective value for the first edge grouping and the first probability is greater than the updated probability.

In some implementations of the example method, the objective function assigns a second objective value to the second edge grouping based on the second set of weights for the second edge grouping and the selection criteria has a second probability of selecting the second edge grouping based on the second objective value for the second edge grouping. In some implementations of the example method, the first probability is greater than the second probability and the second probability is greater than the updated probability.

In some implementations of the example method, updating the first set of weights for the first edge grouping includes generating the first set of updated weights for the first edge grouping such that the selection criteria is less likely to select the first edge grouping based on first set of updated weights for the first edge grouping, as compared to the selection criteria selecting the first edge grouping based on the first set of weights for the first edge grouping.

In some implementations of the example method, updating the first set of weights for the first edge grouping includes for each edge included in the first edge grouping, increasing an initial weight for the edge to an increased weight for the edge such that the first set of updated weights for the first edge grouping included the increased weight for each edge included in the first edge grouping.

In some implementations of the example method, the error syndrome is based on a qubit measurement measured during an execution of a quantum error correction (QEC) code, the MG is based on the QEC code and an error model that includes a set of error mechanisms, each edge of the set of edges corresponds to an error mechanism of the set of error mechanisms. In some implementations of the example method, each edge of the set of edges has a weight based on a prior probability associated with the error mechanism that corresponds to the edge.

In some implementations of the example method, the weight of each edge of the set of edges is based on a logarithm of the prior probability associated with the error mechanism that corresponds to the edge.

In some implementations of the example method, the MG is a hypergraph and each edge in a first subset of the set of edges is a hyperedge.

In some implementations of the example method, determining the set of qubit errors is further based on an ensemble of edge groupings. In some implementations of the example method, the ensemble of edge groupings includes the first edge grouping and the second edge grouping.

In some implementations of the example method, determining the set of qubit errors is further based on a complementary gap algorithm, wherein the complementary gap algorithm computes a gap between the first edge grouping and the second edge grouping.

In some implementations, the example method includes correcting at least a subset of the set of qubit errors in response to determining the set of qubit errors. In some implementations of the example method, the subset of qubit errors corresponds to at least a subset of the set of qubit errors, and correcting the subset of qubit errors includes applying a set of quantum logic gates to the subset qubits to correct a quantum state of the subset of qubits.

In an aspect, the present disclosure provides an example quantum computing system. The quantum computing system includes one or more quantum processors. The one or more quantum processors include one or more qubits. The one or more quantum processors are configured to execute one or more operations. The one or more operations include receiving an error syndrome that identifies a first subset of a set of nodes of a matching graph (MG). The first subset of nodes define a set of edge groupings for a set of edges of the MG. Each edge grouping of the set of edge groupings connects each node of the first subset of nodes with another node of the first subset of nodes or a boundary of the MG. The one or more operations include selecting a first edge grouping of the set of edge groupings based on a first set of weights for the first edge grouping and other sets of weights for at least another portion of the set of edge groupings. The one or more operations include selecting a second edge grouping of the set of edge groupings based on at least a first set of updated weights for the first edge grouping and a second set of weights for the second edge grouping. The one or more operations include determining a set of qubit errors of the QCS based on a comparison between the first edge grouping and the second edge grouping.

In some implementations, the operations include in response to selecting the first edge grouping, updating the first set of weights for the first edge grouping to generate the first set of updated weights for the first edge grouping. In some implementations, the operations include selecting the second edge grouping of the set of edge groupings further based on the other sets of weights for the other portion of the set of edge groupings.

In some implementations, each edge grouping of the set of edge groupings includes a separate subset of the set of edges. In some implementations, each edge of the set of edges has a weight. In some implementations, each edge grouping of the set of edge groupings has a set of weights that includes the weight of each edge of the subset of edges that is included in the edge group.

In some implementations, selecting the first edge grouping and identifying the second edge grouping are further based on an objective function and a selection criteria. In some implementations, the objective function assigns an objective value to each edge grouping of the set of edge groupings based on the set of weights for the edge grouping such that a ranking of the set of edge groupings is defined based on the objective function assigning the objective value to each edge grouping in the set of edge groupings. In some implementations, the selection criteria is employed to select an edge grouping of the set of edge groupings based on the ranking of the set of edge groupings.

In some implementations, the objective value that the objective function assigns to each edge grouping of the set of edge groupings is further based on a summation of each weight of the set of weights for the edge grouping.

In some implementations, selecting the first edge grouping includes comparing a first objective value that the objective function assigns to the first edge grouping to other objective values that the objective function assigns to the other portion of the set of edge groupings. In some implementations, the objective function assigns the first objective value to the first edge grouping based on the first set of weights for the first edge grouping.

In some implementations, selecting the second grouping includes comparing a second objective value that the objective function assigns to the second edge grouping to an updated objective value that the objective function assigns to the first edge grouping. In some implementations, the objective function assigns the updated objective value to the first edge grouping based on the first set of updated weights for the first edge grouping and the objective function assigns the second objective value to the second edge grouping based on the second set of weights for the second edge grouping.

In some implementations, selecting the first edge grouping includes employing the objective function to assign a first objective value to the first edge grouping. In some implementations, assigning the first objective value to the first edge grouping is based on the first set of weights for the first edge grouping. In some implementations, selecting the first edge grouping includes employing the objective function to assign a second objective value to the second edge grouping. In some implementations, assigning the second objective value to the second edge grouping is based on the second set of weights for the second edge grouping. In some implementations, selecting the first edge grouping includes generating a first ranking of the set of edge groupings based on the first objective value assigned to the first edge grouping and the second objective value assigned to the second edge grouping. In some implementations, selecting the first edge grouping includes employing the selection criteria to select the first edge grouping based on the first ranking of the set of edge groupings.

In some implementations, selecting the second edge grouping includes employing the objective function to assign an updated objective value to the first edge grouping. In some implementations, assigning the updated objective value to the first edge grouping is based on the first updated set of weights for the first edge grouping. In some implementations of the example method, selecting the second edge grouping includes generating a second ranking of the set of edge groupings based on the updated objective value assigned to the first edge grouping and the second objective value assigned to the second edge grouping. In some implementations, selecting the second edge grouping includes employing the selection criteria to select the second edge grouping based on the second ranking of the set of edge groupings.

In some implementations, when selecting the second edge grouping based on the second ranking of the set of edge groupings, the selection criteria has a first probability for selecting the second edge grouping over the first edge grouping, the selection criteria has a second probability for selecting the first edge grouping over the second edge grouping, and the first probability is greater than the second probability.

In some implementations, when selecting the first edge grouping based on the first ranking of the set of edge groupings, the selection criteria has a first probability for selecting the first edge grouping over the second edge grouping. In some implementations, the selection criteria has a second probability for selecting the second edge grouping over the first edge grouping, and the first probability is greater than the second probability.

In some implementations, the objective function assigns a first objective value to the first edge grouping based on the first set of weights for the first edge grouping, the selection criteria has a first probability of selecting the first edge grouping based on the first objective value for the first edge grouping. In some implementations, updating the first set of weights for the first edge grouping includes updating at least a first weight of a first edge included in the first edge grouping to generate the first set of updated weights for the first edge grouping such that the objective function assigns an updated objective value to the first edge grouping based on the first set of updated weights for the first edge grouping, wherein the selection criteria has an updated probability of selecting the first edge grouping based on the updated objective value for the first edge grouping and the first probability is greater than the updated probability.

In some implementations, the objective function assigns a second objective value to the second edge grouping based on the second set of weights for the second edge grouping and the selection criteria has a second probability of selecting the second edge grouping based on the second objective value for the second edge grouping. In some implementations, the first probability is greater than the second probability and the second probability is greater than the updated probability.

In some implementations, updating the first set of weights for the first edge grouping includes generating the first set of updated weights for the first edge grouping such that the selection criteria is less likely to select the first edge grouping based on first set of updated weights for the first edge grouping, as compared to the selection criteria selecting the first edge grouping based on the first set of weights for the first edge grouping.

In some implementations, updating the first set of weights for the first edge grouping includes for each edge included in the first edge grouping, increasing an initial weight for the edge to an increased weight for the edge such that the first set of updated weights for the first edge grouping included the increased weight for each edge included in the first edge grouping.

In some implementations, the error syndrome is based on a qubit measurement measured during an execution of a quantum error correction (QEC) code, the MG is based on the QEC code and an error model that includes a set of error mechanisms, each edge of the set of edges corresponds to an error mechanism of the set of error mechanisms. In some implementations, each edge of the set of edges has a weight based on a prior probability associated with the error mechanism that corresponds to the edge.

In some implementations, the weight of each edge of the set of edges is based on a logarithm of the prior probability associated with the error mechanism that corresponds to the edge.

In some implementations, the MG is a hypergraph and each edge in a first subset of the set of edges is a hyperedge.

In some implementations, determining the set of qubit errors is further based on an ensemble of edge groupings. In some implementations, the ensemble of edge groupings includes the first edge grouping and the second edge grouping.

In some implementations of the example method, determining the set of qubit errors is further based on a complementary gap algorithm, wherein the complementary gap algorithm computes a gap between the first edge grouping and the second edge grouping.

In some implementations, the operations include correcting at least a subset of the set of qubit errors in response to determining the set of qubit errors. In some implementations, the subset of qubit errors corresponds to at least a subset of the set of qubit errors, and correcting the subset of qubit errors includes applying a set of quantum logic gates to the subset qubits to correct a quantum state of the subset of qubits.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs (e.g., one or more modules of digital and/or quantum computer program instructions encoded on a tangible non-transitory storage medium for execution by, or to control the operation of, data processing apparatus). The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit (i.e., a system that defines the unit of quantum information). It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states; however, it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc..

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network does not transmit quantum data; however, a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A method for operating a quantum computing system (QCS), the method comprising:
receiving an error syndrome that identifies a first subset of a set of nodes of a matching graph (MG), the first subset of nodes defining a set of edge groupings for a set of edges of the MG, wherein each edge grouping of the set of edge groupings connects each node of the first subset of nodes with another node of the first subset of nodes or a boundary of the MG;
selecting a first edge grouping of the set of edge groupings based on a first set of weights for the first edge grouping and other sets of weights for at least another portion of the set of edge groupings;
selecting a second edge grouping of the set of edge groupings based on at least a first set of updated weights for the first edge grouping and a second set of weights for the second edge grouping; and
determining a set of qubit errors of the QCS based on a comparison between the first edge grouping and the second edge grouping.

2. The method of claim 1, further comprising:
in response to selecting the first edge grouping, updating the first set of weights for the first edge grouping to generate the first set of updated weights for the first edge grouping; and
selecting the second edge grouping of the set of edge groupings further based on the other sets of weights for the other portion of the set of edge groupings.

3. The method of claim 2, wherein each edge grouping of the set of edge groupings includes a separate subset of the set of edges, each edge of the set of edges has a weight, each edge grouping of the set of edge groupings has a set of weights that includes the weight of each edge of the subset of edges that is included in the edge group.

4. The method of claim 3, wherein selecting the first edge grouping and identifying the second edge grouping are further based on an objective function and a selection criteria, and wherein the objective function assigns an objective value to each edge grouping of the set of edge groupings based on the set of weights for the edge grouping such that a ranking of the set of edge groupings is defined based on the objective function assigning the objective value to each edge grouping in the set of edge groupings, and the selection criteria is employed to select an edge grouping of the set of edge groupings based on the ranking of the set of edge groupings.

5. The method of claim 4, wherein the objective value that the objective function assigns to each edge grouping of the set of edge groupings is further based on a summation of each weight of the set of weights for the edge grouping.

6. The method of claim 4, wherein selecting the first edge grouping includes:
comparing a first objective value that the objective function assigns to the first edge grouping to other objective values that the objective function assigns to the other portion of the set of edge groupings, wherein the objective function assigns the first objective value to the first edge grouping based on the first set of weights for the first edge grouping.

7. The method of claim 4, wherein selecting the second grouping includes:
comparing a second objective value that the objective function assigns to the second edge grouping to an updated objective value that the objective function assigns to the first edge grouping, wherein the objective function assigns the updated objective value to the first edge grouping based on the first set of updated weights for the first edge grouping and the objective function assigns the second objective value to the second edge grouping based on the second set of weights for the second edge grouping.

8. The method of claim 4, wherein selecting the first edge grouping includes:
employing the objective function to assign a first objective value to the first edge grouping, wherein assigning the first objective value to the first edge grouping is based on the first set of weights for the first edge grouping;
employing the objective function to assign a second objective value to the second edge grouping, wherein assigning the second objective value to the second edge grouping is based on the second set of weights for the second edge grouping;
generating a first ranking of the set of edge groupings based on the first objective value assigned to the first edge grouping and the second objective value assigned to the second edge grouping; and
employing the selection criteria to select the first edge grouping based on the first ranking of the set of edge groupings.

9. The method of claim 8, wherein selecting the second edge grouping includes:
employing the objective function to assign an updated objective value to the first edge grouping, wherein assigning the updated objective value to the first edge grouping is based on the first updated set of weights for the first edge grouping;
generating a second ranking of the set of edge groupings based on the updated objective value assigned to the first edge grouping and the second objective value assigned to the second edge grouping; and
employing the selection criteria to select the second edge grouping based on the second ranking of the set of edge groupings.

10. The method of claim 9, wherein when selecting the second edge grouping based on the second ranking of the set of edge groupings, the selection criteria has a first probability for selecting the second edge grouping over the first edge grouping, the selection criteria has a second probability for selecting the first edge grouping over the second edge grouping, and the first probability is greater than the second probability.

11. The method of claim 8, wherein when selecting the first edge grouping based on the first ranking of the set of edge groupings, the selection criteria has a first probability for selecting the first edge grouping over the second edge grouping, the selection criteria has a second probability for selecting the second edge grouping over the first edge grouping, and the first probability is greater than the second probability.

12. The method of claim 4, wherein the objective function assigns a first objective value to the first edge grouping based on the first set of weights for the first edge grouping, the selection criteria has a first probability of selecting the first edge grouping based on the first objective value for the first edge grouping, and updating the first set of weights for the first edge grouping includes:
updating at least a first weight of a first edge included in the first edge grouping to generate the first set of updated weights for the first edge grouping such that the objective function assigns an updated objective value to the first edge grouping based on the first set of updated weights for the first edge grouping, wherein the selection criteria has an updated probability of selecting the first edge grouping based on the updated objective value for the first edge grouping and the first probability is greater than the updated probability.

13. The method of claim 12, wherein the objective function assigns a second objective value to the second edge grouping based on the second set of weights for the second edge grouping and the selection criteria has a second probability of selecting the second edge grouping based on the second objective value for the second edge grouping, and wherein the first probability is greater than the second probability and the second probability is greater than the updated probability.

14. The method of claim 4, updating the first set of weights for the first edge grouping includes:
generating the first set of updated weights for the first edge grouping such that the selection criteria is less likely to select the first edge grouping based on first set of updated weights for the first edge grouping, as compared to the selection criteria selecting the first edge grouping based on the first set of weights for the first edge grouping.

15. The method of claim 2, updating the first set of weights for the first edge grouping includes:
for each edge included in the first edge grouping, increasing an initial weight for the edge to an increased weight for the edge such that the first set of updated weights for the first edge grouping included the increased weight for each edge included in the first edge grouping.

16. The method of claim 1, wherein the error syndrome is based on a qubit measurement measured during an execution of a quantum error correction (QEC) code, the MG is based on the QEC code and an error model that includes a set of error mechanisms, each edge of the set of edges corresponds to an error mechanism of the set of error mechanisms, and wherein each edge of the set of edges has a weight based on a prior probability associated with the error mechanism that corresponds to the edge.

17. The method of claim 16, wherein the weight of each edge of the set of edges is based on a logarithm of the prior probability associated with the error mechanism that corresponds to the edge.

18. The method of claim 1, wherein the MG is a hypergraph and each edge in a first subset of the set of edges is a hyperedge.

19. The method of claim 1, wherein determining the set of qubit errors is further based on an ensemble of edge groupings, wherein the ensemble of edge groupings includes the first edge grouping and the second edge grouping.

20. The method of claim 1, wherein determining the set of qubit errors is further based on a complementary gap algorithm, wherein the complementary gap algorithm computes a gap between the first edge grouping and the second edge grouping.

21. The method of claim 1, wherein the QCS includes a set of qubits and the method further comprising:
in response to determining the set of qubit errors, correcting at least a subset of the set of qubit errors, wherein the subset of qubit errors corresponds to at least a subset of the set of qubit errors, and correcting the subset of qubit errors includes applying a set of quantum logic gates to the subset qubits to correct a quantum state of the subset of qubits.

22. A quantum computing system comprising:
one or more quantum processors comprising one or more qubits, the one or more quantum processors configured to execute one or more operations, the one or more operations comprising:
receiving an error syndrome that identifies a first subset of a set of nodes of a matching graph (MG), the first subset of nodes defining a set of edge groupings for a set of edges of the MG, wherein each edge grouping of the set of edge groupings connects each node of the first subset of nodes with another node of the first subset of nodes or a boundary of the MG;
selecting a first edge grouping of the set of edge groupings based on a first set of weights for the first edge grouping and other sets of weights for at least another portion of the set of edge groupings;
selecting a second edge grouping of the set of edge groupings based on at least a first set of updated weights for the first edge grouping and a second set of weights for the second edge grouping; and
determining a set of qubit errors of the QCS based on a comparison between the first edge grouping and the second edge grouping.
